(19) United States
(12) Patent Application Publication
(10) Pub. No.: US 2003/0177228 A1
(43) Pub. Date: Sep. 18, 2003

(54) Adaptative heartbeat flow for cluster node aliveness detection

(76) Inventors: Xavier Vigouroux, Brie et Angonnes (FR); Isabelle Colas, Courbevoie (FR); Florence Blanc, Eybens (FR); Alejandro Lopez, Meylan (FR); Christophe Reiss, Pierre Chatel (FR)

Correspondence Address: PARK, VAUGHAN & FLEMING LLP, 508 SECOND STREET, SUITE 201, DAVIS, CA, 95616, US

(21) Appl. No.: 10/354,333

(22) Filed: Jan. 29, 2003

(30) Foreign Application Priority Data
Feb. 1, 2002 (FR) 0201229

(51) Int. Cl. G06F 15/16; G06F 15/173

(52) U.S. Cl. 709/224; 709/230; 714/4

(57) ABSTRACT

One embodiment of the present invention provides a computer system comprising a first node, adapted to be connected via at least a link to a second node. The first node includes a receiving component capable of receiving repetitively a presence message comprising an indication of a current delay for a status detection of the second node, a handling component capable of determining the status of the second node from a delay derived from received delays, and from the time succession of receipt of said presence messages.

### RELATED APPLICATIONS

This application hereby claims priority under 35 U.S.C §119 to French patent application No. 0201229, filed Feb. 1, 2002, entitled “Adaptive Heartbeat Flow for Cluster-Nodes Aliveness Detection,” Attorney Docket No. SUN Aff. 32.

### RELATED ART

The invention relates to network systems.

Such network systems may have to be highly available, e.g. in comprising a specific node ensuring a good serviceability and good failure maintenance. A pre-requisite is then to have a mechanism in a network to inform some of the nodes of the network that a node has no failure. Such a designation mechanism arises problems.

Thus, the known Transmission Control Protocol (TCP) has a built-in capability to detect network failure. However, this built-in capability involves potentially long and unpredictable delays. On another hand, the known User Datagram Protocol (UDP) has no such capability.

A general aim of the present invention is to provide advances towards high availability.

The invention concerns a computer system comprising a first node, adapted to be connected via at least a link to a second node. Said first node has:

a receiving component capable of receiving repetitively a presence message comprising an indication of a current delay for a status detection of the second node, and

a handling component capable of determining the status of the second node from a delay derived from received delays, and from the time succession of receipt of said presence messages.

The invention also concerns a method of managing a computer system comprising a first node adapted to be connected via at least a link to a second node, said method comprising the following steps:

a. sending from the second node presence messages comprising an indication of a current delay for a status detection of the second node,

b. receiving said presence messages in the first node and

c. determining the status of the second node from a delay derived from received delays, and from the time succession of receipt of said presence messages.

Other alternative features and advantages of the invention will appear in the detailed description below and in the appended drawings.

### BRIEF DESCRIPTION OF THE FIGURES

FIG. 1 is a general diagram of a computer system in which embodiments of the invention are applicable.

FIG. 2A is a general diagram of a monitoring platform having two nodes.

FIG. 2B is a general diagram of a monitoring platform having a plurality of nodes.

FIG. 3 is a table of node and link status.

FIG. 4 is a diagram of a node according to an embodiment of the invention.

FIG. 5 is a flow chart of the sending thread according to an embodiment of the invention.

FIG. 6 is a flow chart of the receiving thread according to an embodiment of the invention.

FIG. 7 is a main flow chart of the handling thread according to an embodiment of the invention.

FIG. 8 is a flow chart of the handling thread connected to the main flow chart of FIG. 7.

FIG. 9 is a flow chart of the handling thread connected to the flow chart of FIG. 8.

FIG. 10 is a first example of chart illustrating the function of the different threads according to an embodiment of the invention.

FIG. 11 is a second example of chart illustrating the function of the different threads according to an embodiment of the invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs) and DVDs (digital versatile discs or digital video discs), and computer instruction signals embodied in a transmission medium (with or without a carrier wave upon which the signals are modulated). For example, the transmission medium may include a communications network, such as the Internet.

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright and/or author's rights whatsoever.

Additionally, the detailed description is supplemented with the following Appendices:

Appendices A-1 through A-4 contain pseudo-code useful for the probe's node failure detection protocol.

These Appendices are placed apart for the purpose of clarifying the detailed description, and of enabling easier reference. They nevertheless form an integral part of the description embodiments of the present invention. This applies to the drawings as well.

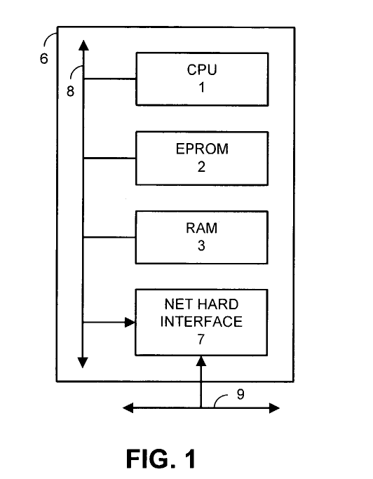

This invention may be implemented in a computer system, or in one or more networks comprising computer systems. Each such computer systems may be referenced to as a node. The hardware of such a computer system 6 is for example as shown in FIG. 1, where:

1 is a processor, e.g. an Ultra-Sparc (SPARC is a Trademark of SPARC International Inc);

2 is a program memory, e.g. an EPROM for BIOS;

3 is a working memory for software, data and the like, e.g. a RAM of any suitable technology (SDRAM for example); and

7 is a network interface device connected to a communication medium 8, itself in communication with other computers. Network interface device 7 may be an Ethernet device, a serial line device, or an ATM device, inter alia. Medium 8 may be based on wire cables, fiber optics, or radio-communications, for example.

Data may be exchanged between the components of FIG. 1 through a bus system 9, schematically shown as a single bus for simplification of the drawing. As is known, bus systems may often include a processor bus, e.g. of the PCI type, connected via appropriate bridges to e.g. an ISA bus and/or an SCSI bus.

References to the drawings in the following description will use two different indexes or suffixes i and j, each of which may take anyone of the values: {1, 2 . . . n}, n being the number of nodes in a group of nodes, meaning the nodes of the group are connected via a physical link.

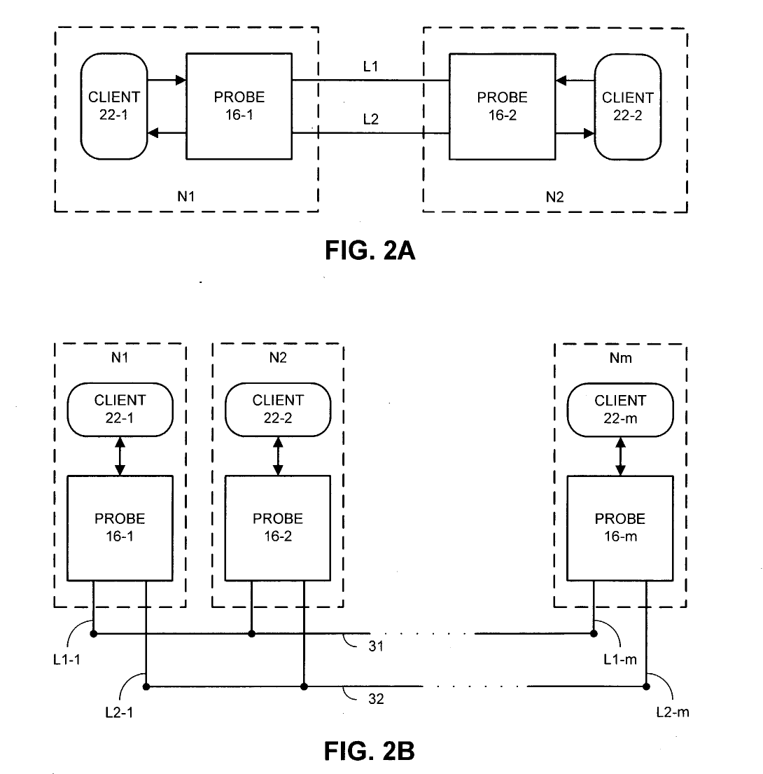

FIG. 2A shows an example of a group of nodes, e.g. a cluster, comprising two nodes N1 and N2.

In FIG. 2A, first node N1 is connected to second node N2 via a first link L1. If desired, the network is also redundant: the node N1 is also connected via a redundant link L2. For example, if node N1 sends a packet to node N2, the packet is therefore duplicated to be sent on both links. The mechanism of redundant links will be explained hereinafter. In fact, the foregoing description assumes that the second link for a node is used in parallel with the first link.

In the following description, a node N may be a monitor node and/or a monitored node. The term monitor node means that the node checks that other nodes are alive or up or accessible. In an embodiment, the monitor node may monitor all the nodes of the group of nodes, or may have a list of nodes to monitor. These nodes to monitor are called monitored nodes.

Each node comprises a module called a probe 16 and a client 22. Probe 16 and client 22, each can be implemented, for example, as software program that are executed by the hardware of the node. In the monitored node N2, the probe 16-2 is adapted to send repetitively a notification (also called a presence message), to indicate the node is “alive”, the probe is therefore designated as a monitored node probe.

These notifications may be broadcasted messages in the form of UDP datagrams. In this case, the probe-related communications may be done by using UDP/IP. Alternatively, these notifications may also be multicasted messages sent to some nodes of a list. These notifications may also be unicasted messages sent to some nodes of a list stored on the network. These repetitive notifications may be termed “heartbeats”.

When the monitor node N I receives the notification, it knows that the monitored node N2 is alive. Since heartbeats are sent through both links L1 and L2, the aliveness of the links can also be verified. The monitored node may be considered to be up or alive while at least one of the links is working (heartbeats are arriving from it). When both links L1 and L2 are down (no heartbeat arriving from the node), then it may be considered to be down. Moreover, in the monitor node, the probe is adapted to receive said notifications from the monitored node probe and to check the monitored node probe (or monitored node) is alive. If the monitor node probe detects a failure in the monitored node/links, the monitor node N1 may send a notification to the client 22-1 adapted to manage status of nodes/links of the group of nodes.

Since each probe manages a list (which can be empty) of the nodes that it is monitoring, many different configurations are possible regarding the role (monitor/monitored) assignations. Thus, nodes N1 and N2 may be both monitor nodes and/or monitored nodes. The list is filled by the client 22-1 communicating with the probe 16. FIG. 2B shows a group of nodes comprising nodes N1, N2 . . . Nn interconnected via a first network 31. If desired, the network is also redundant: nodes may be interconnected via at least a second network 32. A link L1, respectively L2, for a node may be seen as the connection of the node to a network 31, respectively 32. Thus, the number of links per node to interconnect the node to a network may increase when the number of networks being used increases.

Each node's link is connected to a network where the heartbeats (UDP datagram) may be broadcasted, and each link in a node is on a different network. Each network is independent from the others. As a simplification, there are as many networks as links per node, and they are fully disjoint.

As seen, many configurations are possible. One of the simplest is one monitor node monitoring all the other nodes. To prevent from a single-failure point (the monitor node), a second monitor node monitors the first monitor node. Both the first and second monitor nodes are at the same time monitor and monitored nodes: first monitor node monitors the second monitor node and reciprocally. Moreover, the first monitor node monitors all the other nodes of the group of nodes.

When a monitor node loses one of its links, the monitor node probe stops receiving heartbeats from the monitored links on that network. Then, the monitor node probe detects that the monitored links are down and sends corresponding notifications to its client 22. The client may interpret this as a local link failure. When all the monitored links of a monitored node probe are down, a notification is sent to the client. The client may interpret this as a network failure. As mentioned previously, client 22 and probe 16 can be implemented in software executed by the node's CPU I of computer system 6. Network protocol stack 10 and link level interfaces 12 and 14 can likewise be implemented in software and/or in dedicated hardware such as the node's network hardware interface 7.

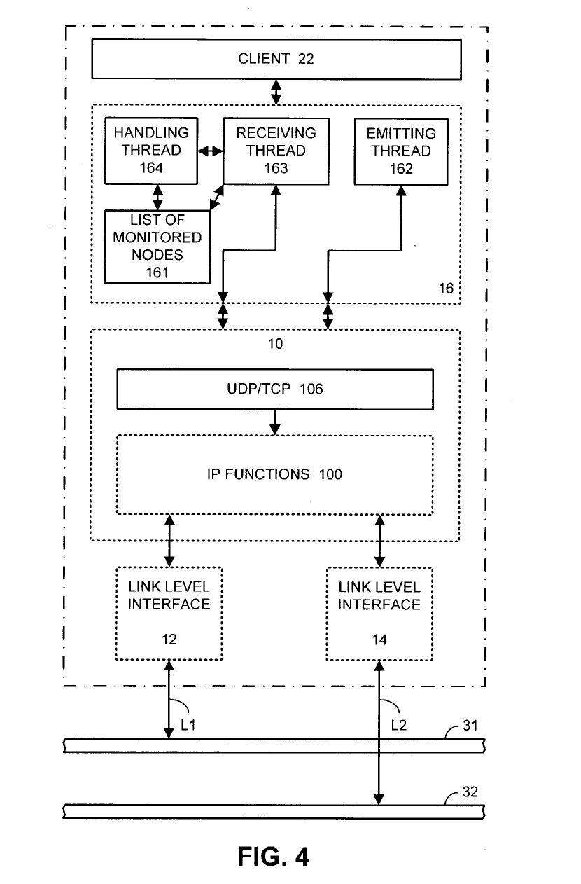

FIG. 4 shows an exemplary node Ni, in which the invention may be applied. Node Ni comprises, from top to bottom, the client layer (or management layer) 11, the probe 16, a network protocol stack 10, and Link level interfaces 12 and 14, respectively connected to network 31 and 32.

As described, the client layer 22 is adapted to list the nodes monitored by the node Ni. The probe 16 comprises the list of monitored nodes 161 provided and updated by the client layer 22.

Each probe 16 has a list of the nodes that it is monitoring. This permits a probe to be monitor and monitored at the same time, and even to monitor a sub-set of nodes instead of all the nodes of the group.

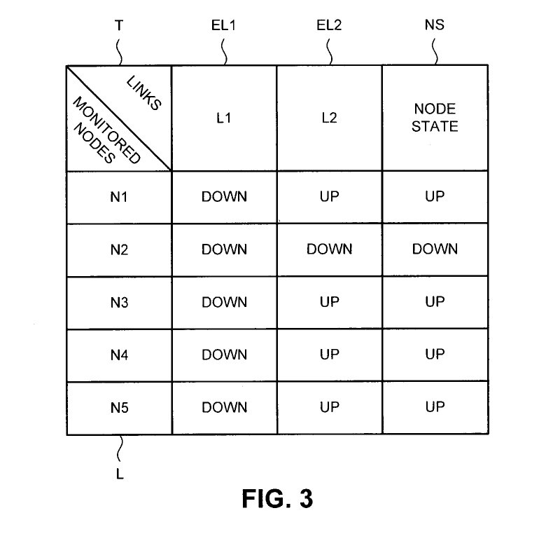

As illustrated in FIG. 3, for each monitored node of a list L, an entry EL1, EL2 may be included for each link, this list L may be a table T. This way, each node's link may be treated separately to be able to identify problems that affect just one link and not the entire node.

The probe also comprises an emitting thread 162 adapted to send repetitive notification indicating the node is alive to nodes of the cluster and to work with a memory for data sent in these notifications, a receiving thread 163 adapted to receive notifications from nodes of the cluster and to store, in the table T of FIG. 3, changes in node/link status, a handling thread 164 adapted to detect the changes in node/link status and to store these changes in the table T of FIG. 3. Flow charts of the following figures will detail the role of threads.

Node Ni may be part of a local or global network; in the foregoing exemplary description, the network is an Ethernet network, by way of example only.. It is assumed that each node may be uniquely defined by a portion of its Ethernet address. Accordingly, as used hereinafter, “IP address” means an address uniquely designating a node in the network being considered, whichever network protocol is being used. Although Ethernet is presently convenient, no restriction to Ethernet is intended.

Thus, in the example, network protocol stack 10 comprises:

an IP interface 100, having conventional Internet protocol (IP) functions,

above IP interface 100, message protocol processing functions, e.g. an UDP function and/or a TCP function 106. The notifications as presence messages (or heartbeat) are advantageously sent with the UDP protocol.

Network protocol stack 10 is interconnected with the physical networks through first and second Link level interfaces 12 and 14, respectively. These are in turn connected to first and second network channels 31 and 32, via L1-i and L2-i for the exemplary node Ni. More than two channels may be provided, enabling to work on more than two copies of a packet.

IP interface 100 comprise encapsulating a message coming from upper layer 106 into a suitable IP packet format, and, conversely, de-encapsulating a received packet before delivering the message it contains to upper layer 106.

Amongst various transport internet protocols, the transport protocol used is advantageously the UDP protocol. Thus, packets are sent from a definite source to nodes of the network, or to a group of nodes (nodes of the cluster, of different clusters, etc). The node destination address may not be useful. The messages may also use the Transmission Control Protocol (TCP), when passing through function or layer 106.

At reception side, packets are directed through the Link level interfaces 12 and 14. Packets are then directed to the network protocol stack 10.

In the following description, the detection delay is the longest amount of time that can pass before the link failure of a monitor node is noticed by the monitor node.

In previously known systems, a monitor node defines a detection delay for monitored nodes. At reception of a heartbeat, the monitor node detects the monitored node as alive and a timer is launched. When the detection delay is reached and no heartbeat has been received from the monitored node, this monitored node is detected as down. As the detection delay depends on each monitor node, detection problems may appear. Thus, at a given time, a first monitor node having a first detection delay may detect a node as down when a second monitor node having a second detection delay may detect the node as up.

In the described invention, the heartbeat is an UDP datagram broadcasted through a link to indicate that the link and the probe in the node are alive. It contains a data structure including at least two fields (as shown in Appendix A-1): version and delay.

The version field stores the version of the protocol in use, e.g. version 1 or version 2. Here, version 1 is considered to designate a conventional heartbeat having no second field as hereinafter described, contrary to version 2 according to embodiments of the invention.

The second field, delay, indicates to the receiving probe what is the sender's detection delay. It may be expressed in milliseconds. This information is sent by every monitored nodes. Indeed, every monitored node may have a different detection delay. Thus, a very important node could have a low detection delay while a less important node could have a longer one.

The detection delay of a given monitored node may be similar in each heartbeat and may be stored in a memory working in relation with the emitting thread. It thus insures coherency of failure detection in every monitor node receiving these heartbeats and monitoring this monitored node.

By sending the current detection delay in every heartbeat, only one message type may be used, simplifying the reception routine. On the contrary, if the detection delay was sent in a separate message whenever it changed, an acknowledge mechanism should be implemented because of the risk-of-loss of the UDP datagram. This would also imply that the monitored node should know which nodes monitor it.

For a UDP datagram, no sender information may be needed since the datagram includes the sender's IP address, which identifies a unique link in a unique node. In the case of other protocol used, the sender's address may be needed.

The emitting thread 162 of a probe 16 may send through each link a pre-specified number of heartbeats per detection delay.

To detect a failure of a node/network according to the invention, a probe is adapted to use a table T as illustrated in FIG. 3. Thus, the table T of FIG. 3 enables the probe of a monitor node to store the status of each link of each monitored node.

Each link L1 is connected to the network 31. Each link L2 is connected to the network 32.

Thus, as illustrated in the example, the status of each link L1 and L2 for each monitored node N1, N2, N3, N4, N5 of the list L is stored in the table T. The probe sends a notification to the monitor client to inform of the status of the links. As illustrated in the table T, when the probe detects that each link L1 of each monitored node is down, it may be assumed that the corresponding network 31 is down. As illustrated in the table T, when the probe detects that each link of a node is down, e.g. links L1 and L2 of the node N2 in the example, the node is detected as down. Else, if at least one link is detected as up for a node, the node is considered as alive (or up). The probe 16 sends a notification to the monitor client 22 to inform of the status of the monitored nodes.

In the example of the table T of FIG. 3, the columns indicate the links and the rows indicate the nodes: if a whole column is filled with “down”, this means that each link (e.g. L1) of monitored nodes connected to a network (e.g. 31) is down, the corresponding network may be down; if a whole row is filled with down, this means that each link of the corresponding monitored node is down. In this last case, the node is down or inaccessible.

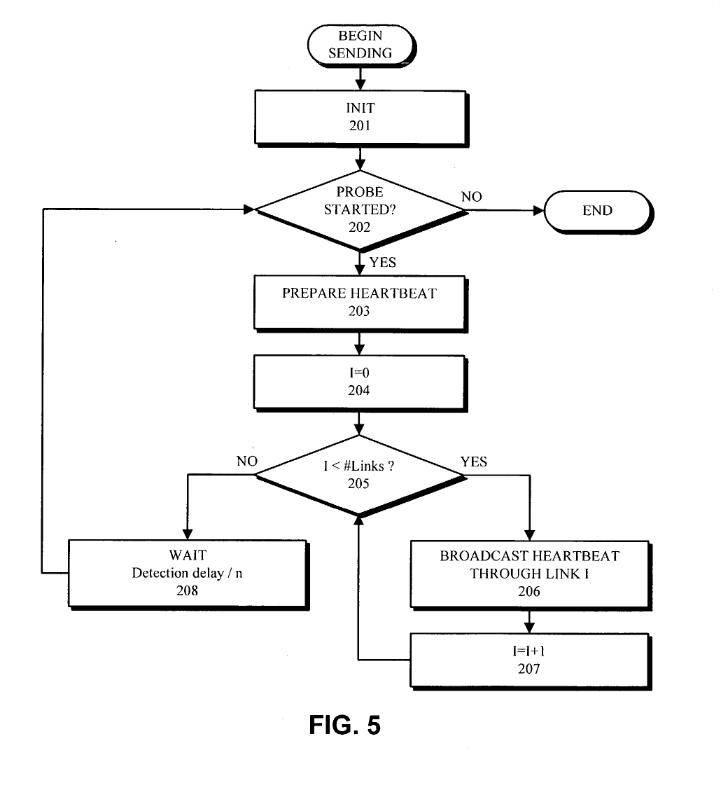

Flow chart of FIG. 5 illustrates the sending of a presence message (or heartbeat) in the emitting thread of a monitored node.

The probe of a node can be in various states, in particular in two states: started and stopped. Thus, when started, the probe sends periodically heartbeats indicating its aliveness through all the links of the node. These heartbeats are transmitted as UDP broadcast datagram. As described, the heartbeat contains the detection delay of the monitored node. This detection delay may also be different for each link of the monitored node. When stopped, the probe does not send any heartbeat.

After initialization of the emitting thread (operation 201) and if the probe is in a started state (operation 202), the probe prepares the heartbeat (operation 203) to send. Else, if the probe is in a stopped state at operation 202, the flow chart ends.

The initialization comprises the initialization of variables needed to send heartbeats (e.g. socket).

Links of the monitored node may be designated with an address (e.g. IP address). For simplification in the flowchart, the links of the monitored node are designated with a variable I being an integer. The variable I is initialized to zero (operation 204). If the variable I is inferior to the number of links in the monitored node (operation 205), a broadcast heartbeat is sent through the link I (operation 206). The variable I is incremented with I (operation 207) before returning to operation 205.

Thus, in this embodiment, each link of the node sends a heartbeat with a detection delay. In another embodiment, only some of the links may send a heartbeat. The detection delay indicated in a heartbeat may be similar for each link of a monitored node. The detection delay may also be different for each link of a monitored node.

In the following description, a time-out is the current time added to the received detection delay. A time-out is reached may be designated as the “end of the detection delay”.

Each link in a node is treated separately, meaning that a different heartbeat is sent through each link and a separate time-out is stored in the monitor node as described in the receiving thread. This allows for the early detection of individual link failure while the node as a whole is still working.

When heartbeats are sent, the emitting thread waits for a period of time before sending other heartbeats in the same links I of the monitored node (operation 208). This period of time may be calculated as shown in Appendix A-2. The period of time defines the time between a first sending of a heartbeat and a successive sending of a second heartbeat. n is the number of heartbeats sent per detection delay. The value of n depends on the monitored node and could be varied during the lifetime of the probe depending on the importance of the node, the available bandwidth, the percentage of CPU used, etc. As an example, n may be defined as in Appendix A-3. At reception side, when the time-out is reached, it is checked at least one of heartbeat has been sent amongst the n heartbeats during the detection delay.

When the heartbeats are broadcast:

only one heartbeat is sent whatever the number of monitor node probes;

the monitored nodes do not need to keep an identification of the monitor nodes.

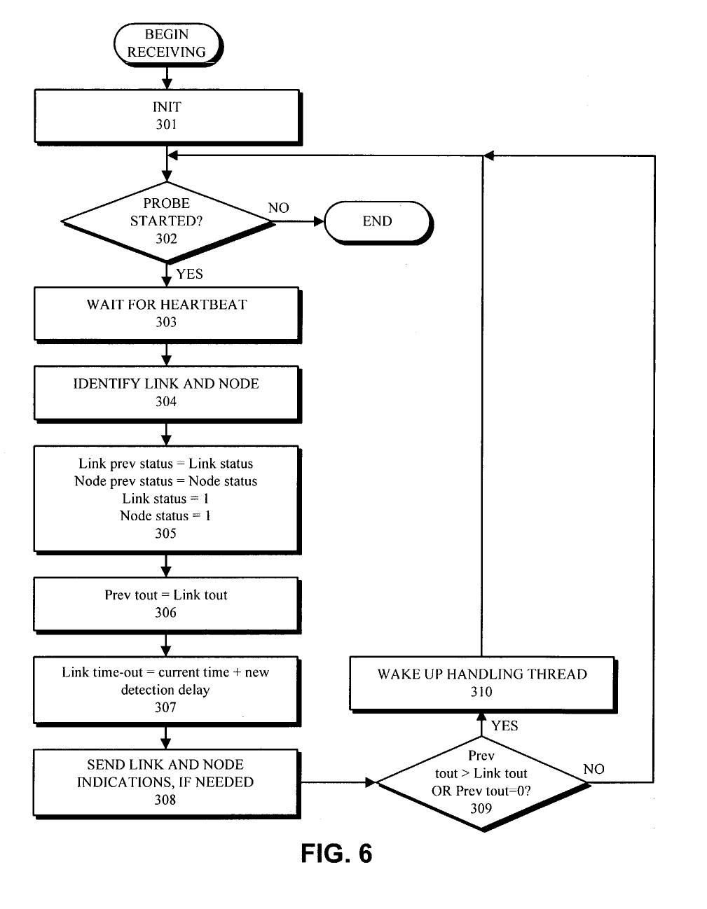

In the descriptions of following flow-charts 6, 7, 8, 9, the variables are designated in italics. Flow chart of FIG. 6 illustrates the reception of a presence message (or heartbeat) in the receiving thread of a monitor node, the other flow charts illustrate the handling of a presence message (or heartbeat) in the handling thread of a monitor node.

Some variables such as “link status” and “node status”, respectively designating the status of a link of a monitored node and the status of said monitored node, are shared between the flow chart of the receiving thread and the flow chart of the handling thread. On the contrary, the variable “previous time-out” is specific to the flow chart of the receiving thread and designates if the previous time-out of the corresponding link was reached (previous time-out=0), then the node was in a down status, or if the previous time-out of the corresponding link was not reached (previous time-out>0) and then the node was in an up status. Moreover, the variable “first-time-out” is specific to the flow chart of the handling thread and designates the next time-out to be reached between all the links time-out of the table T of monitored nodes.

In FIG. 6, the receiving thread of a monitor node is initialized at operation 301, e.g. variables to receive heartbeats (socket). In the monitor node, the variables for a monitored nodes are initialized when this monitored node is added to the list of monitored nodes, e.g. the link status and node status are initialized to 0, respectively meaning that the links of this monitored node are down and the node is down.

If the probe is in a stopped state at operation 302, it does not accept any arriving heartbeat. The flow chart ends and the arriving heartbeats are lost. On the contrary, if the probe is in a started state at operation 302, it waits for a reception of a heartbeat at operation 303. When the monitor node receives a heartbeat, it identifies the link and the node which sent this heartbeat (operation 304). Only the heartbeat received from a node monitored by the monitor node are kept. Thus, the identification of the node is checked to be in the list of monitored nodes, else the heartbeat is discarded. The version of the heartbeat is checked: in the example,

if it is a version 1, then a default detection delay (5000 ms) is assigned,

if it is a version 2, it is used as it arrived with its field detection delay. In the example, other versions may be discarded.

Then, at operation 305, the receiving thread updates its internal information to keep the previous status of the link and of the node respectively in the link previous status and the node previous status variables and to indicate that the sender link is up (link status=1) and the node is also up (Node status=1) if not already indicated. Indeed, as at least one heartbeat has been sent in a link of this node, the node is up (node status=1). At operation 306, the receiving thread updates its internal information to keep the previous time-out of the link in the prev tout tout. The receiving thread updates its internal information to set the link's next time-out in the variable link tout (also called link time-out) at operation 307. Thus, the time-out for the link is calculated as the received detection delay added to the current time.

When the status of a link (and may be of a node) changes, an indication is sent from the monitor node to its client at operation 308.

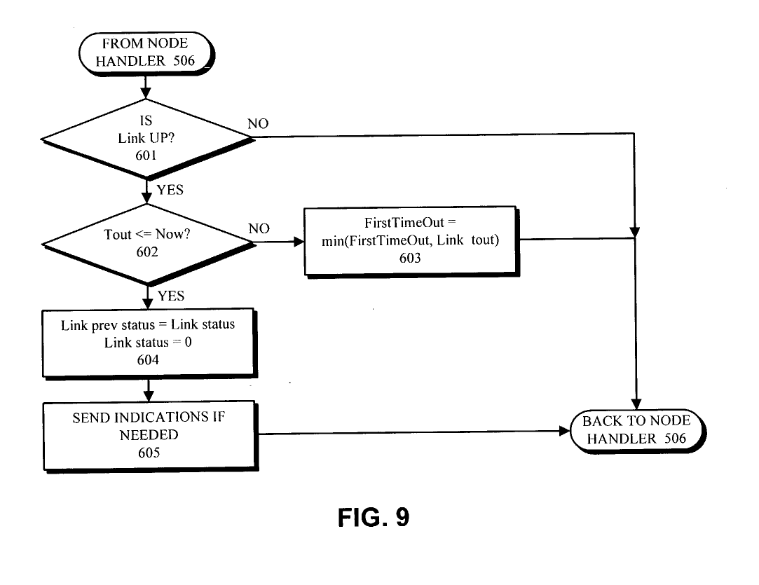

At operation 309, when a first heartbeat from a link arrives to the monitor node, this first heartbeat being the very first heartbeat or the first heartbeat after a period where the node was down, the previous time-out is null. In this case, since the monitored node was down and no detection delay for this link (or link time-out) was available, the first time-out variable was chosen, as illustrating hereinafter in FIG. 9, without taking into account this link's time-out. This means that this new link's time-out could happened before the first time-out expected. To check this and, if needed, correct the situation, the handling thread is awakened by sending it a message (e.g., through a pipe) at operation 310. In other words, the handling thread is awakened if a link was detected as a down link and its status changes.

A similar situation can happen if the heartbeat arrives from an already-known link, but the detection delay is significantly shorter than the previous one. This case is analyzed by comparing the new calculated time-out, also called the current time-out, with the previous time-out. If the new time-out (the link time-out) happens before the previous one at operation 309, meaning the new time-out is smaller than the previous one, the handling thread is awakened at operation 310.

After operation 309 or 310, the flowchart of FIG. 6 continues at operation 302.

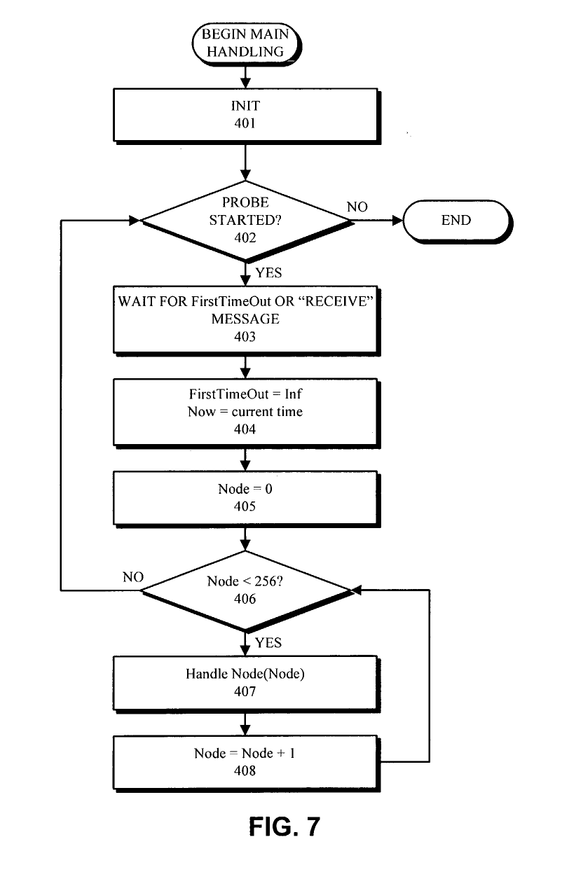

The flow charts of FIGS. 7, 8 and 9 illustrate the handling of a presence message (or heartbeat) in the handling thread of a monitor node.

Link status, link previous status, node status, node previous status designate the status of nodes/links and may have the value 0 for a down status and the value 1 for an up status link and node designate the number of a link/node being an integer.

After initialization of the handling thread (operation 401), if the probe is in a stopped state (operation 402), the flow chart ends. If the probe is in a started state (operation 402), the handling thread stays in a waiting state. Thus, at operation 403, the handling thread waits for:

the variable first-time-out reached, having the default value infinite or having the smallest link's time-out of all monitored node of the table T of monitored node,

a notification received from the receiving thread from operation 310 of FIG. 6.

At operation 404, the first time-out is initialized to the infinite value and the time (Now) is set to the current time.

For simplification in the flowchart, each node is designated with a given number which can be from 0 to a determined number of nodes. In the example, the determined number of nodes in a cluster is 255.

In the embodiment of FIG. 7, all nodes are handled each time the flow chart of the handling thread is activated. In another embodiment, the handling thread may only handle the node having a link's time-out reached or being the cause of the notification sent from the receiving thread to the handling thread.

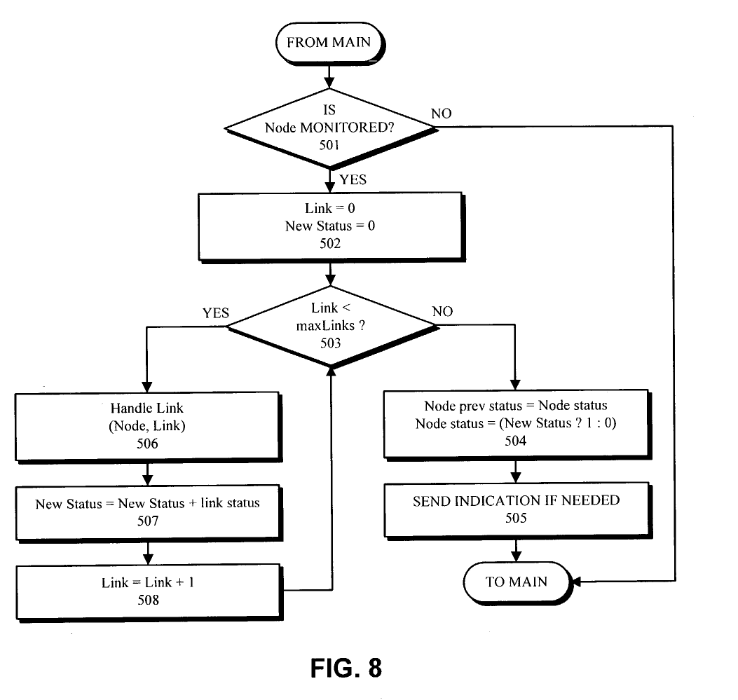

Thus, beginning from the node zero (operation 405), if this node number is smaller than the maximal number of nodes (operation 406), the node is handled (operation 407) as developed in flow-chart FIG. 8. The successive nodes are thus handled (operation 408) from operations 406 to 408, until the node number reaches the maximal number of nodes. The flow chart returns to operation 402.

The flowchart of FIG. 8 is a development of the node handling operation 407 of FIG. 7. Thus, it is checked the handled node is a monitored node (operation 501). If so, link and new status are initialized to zero at operation 502. At operation 503, if it remains a link to handle, this link of the monitored node is handled at operation 506, developed in flow-chart of FIG. 9, returning the link status. The new status is added with the link status at operation 507. The successive links of the monitored node are thus handled (operation 508) from operations 503 to 508, until the link number reaches the maximum link number and the flow chart returns to operation 503. Thus, at operation 507, if all links of the monitored node are down, (link status=0), the new status remains equal to zero. If at least one link of the monitored node is up, (link status=1) then the new status is at least equal to 1.

At operation 503, if the link number reaches the maximum link number, all the links of the monitored node have been handled. Thus, the previous status of the monitored node is updated according to the node status and the node status is updated according to the new status (operation 504). Thus, in operation 504, the expression ”node status=(New status?1:0) means that if new status=0, then the node is considered to be down (node status=0); on the contrary, if new status>1, the node is up (node status=1). If the status of the monitored node has changed, the client layer is notified (operation 505). The main flow-chart of FIG. 7 continues.

The flowchart of FIG. 9 is a development of operation 506 of FIG. 8. The status of the handled link is checked at operation 601. If the link does not send at least one heartbeat before its time-out (Tout) indicated in the table T, it may be considered as being down. Once the handled link starts sending heartbeats again, its status may be changed to up. Thus, if the link is down, the flowchart returns to operation 506 of FIG. 8 with the link status as down. If the link is up, it is checked if its time-out (Tout) is over at operation 602. If it is, the previous link status is updated to the link status value, and the link status is updated to 0 (the link is down) at operation 604. Indications of the link status are sent if needed at operation 605 to the client layer of the node.

If the time-out (Tout) is not over at operation 602, the first-time-out is chosen between the minimum of the link's time-out value and the previous value of first-time-out at operation 603.

The flowchart continues at operation 506 of FIG. 8.

The flowcharts of FIGS. 7, 8, 9 concerning the handling thread are based on the corresponding pseudo-code of Appendix A-4.

Improvements of this protocol comprise:

on-the-fly modification of the detection delay

asymmetric monitoring,

simplification of debugging, testing and maintenance,

Low CPU usage,

scalability.

The detection delay of a link (or node) can be modified to adapt the bandwidth use or CPU use to the needs of the moment. It is done by sending the detection delay in the heartbeat as described above.

If each node is monitoring the other nodes and each node has a different detection delay, then the monitoring is asymmetric.

The protocol has also been conceived to allow each link to have a different detection delay and enables asymmetric monitoring

Since the aliveness check for a link may be done only when its time-out expired, the link is allowed to go down for a short time and then up again, and the monitor node probe may not detect it.

Setting a high detection delay for a link permits this link to go down for a longer period, which can be used to:

test/replace a monitored link

test/replace monitored node

test/replace monitored node probe

debug a monitored node probe.

The only restriction is that the probe (even a new one) must be up early enough to send a heartbeat before the end of the detection period.

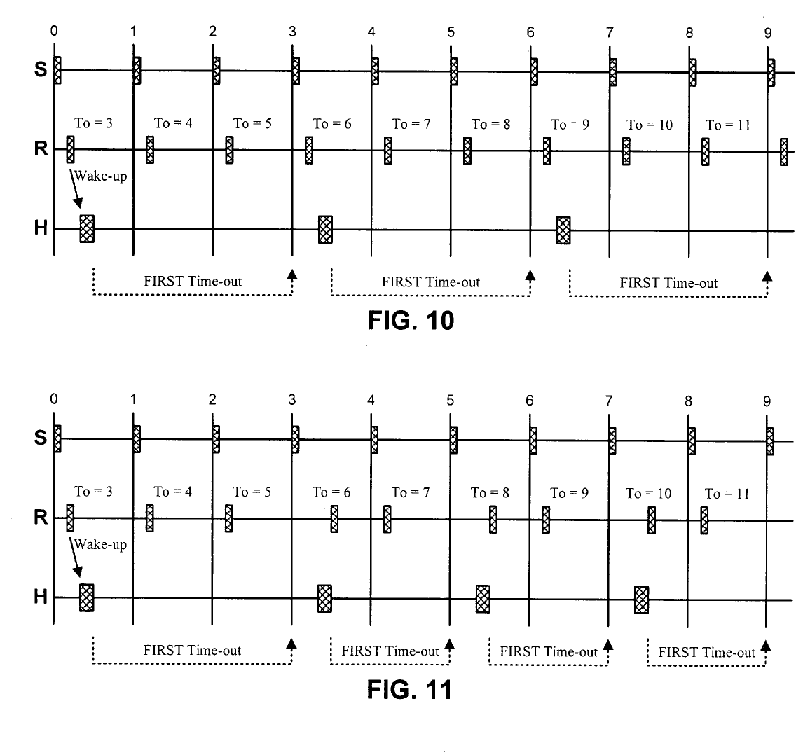

In the charts of FIG. 10 and 11, the CPU usage is shown in different situations as an example. The first chart shows the best case, while the second one shows the worst case. In both cases, it can be seen that CPU usage is quite low.

In the charts, S, R, and H represent the Sending, Receiving and Handling threads and their evolution through the time (in seconds), in a probe that is only monitoring one of its links for simplicity of both examples. The detection delay is set to 3 seconds, and the n is also 3, so one heartbeat per second should arrive.

The blocks represent the execution of the corresponding thread.

Near the execution of the Receiving thread is displayed the new time-out calculated using the newly arrived detection delay.

The Handling thread and the Reception thread never execute at the same time because each thread does not access to the shared information (the list of monitored nodes/links and their status) at the same time.

In the first example, every second the Sending thread sends a heartbeat, it is received by the Receiving thread afterwards. At time 0, the Handling thread is blocked waiting to be awakened by the Receiving thread.

Once awakened, the Handling thread checks the nodes and links, may update the status and send notifications to the client as needed. Then it may sleep until the next time-out, the first one to happen. In the example, it may not be awakened again by the Receiving thread because no new link may show up.

In this case, the Handling thread is executed after the Receiving thread. This maximizes the sleeping time. But this behavior is not guaranteed since it depends of the decisions made by the scheduler. This behavior may be fixed by rising the priority of the receiving thread. The Handling thread may sleep for 3 seconds (the detection delay) minus its execution time.

In the second example, the Handling thread is scheduled before the Receiving thread. Thus, the first time-out is calculated before the Receiving thread updates the time-out of the link. Thus, the first time-out to arrive is 2 seconds after the execution of the Handling thread instead of 3 seconds.

This shows that the handling thread may sleep in the worst case, 2 seconds minus its execution time.

Concerning the other two threads, the time between sending a heartbeat and receiving this heartbeat is short, almost negligible (between some milliseconds to about tenth of second).

The Handling thread's sleeping time corresponds to a waiting time and may have a value included in the following interval:

This sleeping time doesn't depend on the number of monitored nodes.

The invention is not limited to the herein above-described features.

For example, the n value may be changed on the basis of a user decision. This value may also be changed on external process responsive to the importance of the node, the available bandwidth, the percentage of CPU used, etc.

In another embodiment, the value n may be in the structure of a heartbeat. Thus, the monitor node may use this value n to provide a sharper detection of failure of monitored nodes.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

[image]

What is claimed is:

1. A computer system comprising a first node, adapted to be connected via a link to a second node, said first node having:
a receiving component capable of receiving presence messages from the second node, each presence message comprising an indication of a delay associated with the second node; and
a handling component capable of determining the status of the second node from a delay derived from received delays, and from the time succession of receipt of said presence messages.

2. The computer system of claim 1, wherein the receiving component is capable of storing the end of a previous delay of the second node and the end of a current delay of said second node.

3. The computer system of claim 1, wherein the receiving component is further capable of activating the handling component if a presence message is received from the second node and responsive to a result of a comparison between the end of the previous delay for status detection and the end of the current delay for status detection indicated in the received presence message from the second node.

4. The computer system of claim 1, wherein the receiving component is capable of activating an handling component if a presence message is received from the second node and if the end of the previous delay for status detection is smaller than the end of the current delay for status detection indicated in the new received presence message from the second node.

5. The computer system of claim 1, the receiving component is capable of activating an handling component if a presence message is received from the second node and the previous status of the second node was down.

6. The computer system of claim 1, wherein the handling component and the receiving component are capable of storing the status of the second node and modifying it responsive to status changes.

7. The computer system of claim 1, wherein the receiving component is capable of receiving presence messages comprising an indication of the link being used to connect first and second nodes.

8. The computer system of claim 1, wherein the handling component is capable of determining the status of the link being used to connect first and second node responsive to the end of the current delay for status detection of said second node or responsive to an activation from the receiving component.

9. The computer system of claim 1, wherein the handling component is capable of determining the status of a node as down if its links status are all down.

10. The computer system of claim 1, wherein the receiving component is capable of determining the status of a node as up if at least one links status is up.

11. The computer system of claim 1, wherein the first node is further capable of being connected via links to additional nodes.

12. The computer system of claim 1, wherein the first node is further capable of monitoring a list of nodes comprising the second node and some of these additional nodes.

13. The computer system as claimed in any of the preceding claims, wherein the first node is further capable of storing the node and link status in the list of nodes being a table.

14. The computer system of claim 1, wherein the handling component is further capable of determining the status of the links of nodes in the list of nodes responsive to the minimum end of the current delay between the ends of the current delay of nodes of the list of nodes.

15. The computer system of claim 1, wherein the determined number of presence messages is dynamically modifiable.

16. A computer system comprising a node, wherein said node has an emitting component, being in a high level layer, capable of working with a memory having the detection delay of the node, the emitting component being adapted to repetitively send a presence message comprising an indication of a delay for a status detection of said node.

17. The computer system of claim 16, wherein the emitting component is capable of sending a determined number of presence messages during a delay for status detection.

18. The computer system of claim 16, wherein the determined number of presence messages is dynamically modifiable.

19. A method for managing a computer system comprising a first node adapted to be connected via at least a link to a second node, said method comprising the following steps:
a. sending from the second node presence messages comprising an indication of a current delay for a status detection of the second node;
b. receiving said presence messages in the first node; and
c. determining the status of the second node from a delay derived from received delays, and from the time succession of receipt of said presence messages .

20. The method of claim 19, wherein step b. further comprises storing the end of a previous delay of the second node and the end of a current delay of said second node.

21. The method of claim 19, wherein step c. further comprises determining the status of the second node if a presence message is received from the second node and responsive to a result of a comparison between the end of the previous delay for status detection and the end of the current delay for status detection indicated in the received presence message from the second node.

22. The method of claim 19, wherein step c. comprises determining the status of the second node,
c1. if a presence message is received from the second node, and
c2. if the end of the previous delay for status detection is smaller than the end of the current delay for status detection indicated in the received presence message from the second node.

23. The method of claim 19, wherein step c. further comprises determining the status of the second node,
c1. if a presence message is received from the second node and
c2. if the status of the second node was down.

24. The method of claim 19, wherein step c. comprises storing the status of the second node and modifying it responsive to status changes.

25. The method of claim 19, wherein step b. comprises receiving presence messages comprising an indication of the link being used to connect first and second node.

26. The method of claim 19, wherein step c. comprises determining the status of the link being used to connect first and second node responsive to the end of the current delay for status detection of said second node or responsive to the steps c1. and c2.

27. The method of claim 19, wherein step c. comprises determining the status of a node as down if its links status are all down.

28. The method of claim 19, wherein step c. comprises determining the status of a node as up if at least one links status is up.

29. The method of claim 19, wherein step b. and step c. are repeated for additional nodes connected via links to the first node.

30. The method of claim 19, wherein step b. comprises handling presence message received from a list of nodes comprising the second node and some of these additional nodes.

31. The method of claim 19, wherein step c. comprises storing the node and link status in the list of nodes being a table.

32. The method of claim 19, wherein step c. comprises determining the status of the links of nodes in the list of nodes responsive to the minimum end of the current delay between the ends of the current delay of nodes of the list of nodes.

33. The method of claim 19, wherein step a. comprises sending a determined number of presence messages during a delay for status detection.

34. The method as claimed in claim 33, wherein the determined number of presence messages of step a. is dynamically modifiable.

35. A computer-readable storage medium storing instructions that when executed by a computer cause the computer to perform a method for managing a computer system comprising a first node adapted to be connected via at least a link to a second node, said method comprising the following steps:
a. sending from the second node presence messages comprising an indication of a current delay for a status detection of the second node;
b. receiving said presence messages in the first node; and
c. determining the status of the second node from a delay derived from received delays, and from the time succession of receipt of said presence messages.
